(19) United States
(12) Patent Application Publication
(10) Pub. No.: US 2010/0091325 A1
(43) Pub. Date: Apr. 15, 2010

(54) FIELD DATA CENTER

(75) Inventors: Jamie Strachan, Salinas, CA (US); Johnny McGuire, Watsonville, CA (US); Mike Scott, Salinas, CA (US)

Correspondence Address: LARIVIERE, GRUBMAN & PAYNE, LLP, 19 UPPER RAGSDALE DRIVE, SUITE 200, MONTEREY, CA, 93940, US

(73) Assignee: TrueTrac, LLC, Salinas, CA (US)

(21) Appl. No.: 12/572,259

(22) Filed: Oct. 1, 2009

(30) Foreign Application Priority Data
Oct. 4, 2008 (US) PCT/US08/78880

(51) Int. Cl. G06F 15/00

(52) U.S. Cl. 358/1.15

(57) ABSTRACT

The present invention provides, among other features, a device and method for removably enclosing other devices. This device is ruggedized and mobile while also providing protection to the other devices from harsh conditions. Further, this device may integrate and/or contain electronics capable of providing power to other devices. The power components should be able to receive power from an AC or DC source and output, to one or more devices, AC and/or DC. This device is adapted for use in the agricultural harvesting process.

### CROSS-REFERENCE TO RELATED DOCUMENTS

This non-provisional application is based on and claims priority to PCT Application Ser. No. PCT/US08/78880 filed on Oct. 4, 2008 and U.S. application Ser. No. 12/245,732 filed on Oct. 4, 2008.

### TECHNICAL FIELD

The present invention relates to a device and method integrating and/or containing equipment for field use. More specifically, the present invention relates to a device and method for integrating and/or containing one or more other devices into an enclosure for their use in harsh conditions.

### BACKGROUND ART

Tracking and tracing of agricultural commodities and produce products is typically based on a bulk commodity system of traceability. Bulk level traceability is no longer sufficient given production and sourcing practices in the food industry.

An item level tracking system has been built as described in PCT Application Ser. No. PCT/US08/78880 and U.S. application Ser. No. 12/245,732 (hereinafter “prior applications”), that would built that would provide for automatic gathering, management, and reporting of all crop related information. The information gathered would produce a crop data profile, which is associated with a unique identifier. This entails building an intuitive computing infrastructure.

As disclosed in the prior application, a system and method is needed to provide individual item with an appropriate tag (also referred to as label or fastener). This tag may be a Produce Traceability Initiative compliant tag. For this, certain data is required, some of which may be associated with the GPS coordinate where the item was harvested. To appropriately match the GPS coordinate with the harvested item, the tag should be affixed in the field. The prior applications provide for the appropriate system and methods. These applications disclose various devices, including a printer and a computing device, potentially among others. To efficiently tag each harvested item, these devices must be in the field with the goods as they are harvested.

As well known, fields, where many of the items are harvested, can be harsh environments for devices, especially electronic ones. These harsh environments include dirt and foreign particles, greater variances in humidity and temperature, and many other non-optimal characteristics. These devices need protection from these harsh environments.

Further, the previously mentioned devices may have electrical needs. Of course, standard outlets are typically not found in the middle of a field. Power typically is a necessary ingredient.

Thus, there is a need for a device to be capable of integrating and/or containing other devices, and some of these other devices have very specific requirement to meet the aforementioned needs. Further, this device must appropriately support varying needs to the other devices, such as aid in the providing of electrical power.

Continuing, this device must also be mobile and not necessarily fixed to any other item. For example, this device should be capable of being operated on a harvester, in a field-crew bus, truck or any other vehicle.

Moreover, this device must itself be adapted to withstand harsh conditions while protecting the integrated and/or contained other devices from those harsh conditions.

While there are vast benefits obtained from the aforementioned item level tracability, implementing it is difficult. This device helps to overcome these difficulties.

### SUMMARY OF THE INVENTION

The present invention provides, among other features, a device and method for removably enclosing other devices. This invention must be ruggedized and mobile while also providing protection to the other devices from harsh conditions. Further, this device may integrate and/or contain electronics (hereinafter “power components”) capable of providing power to the other devices. The power components should be able to receive power from an AC or DC source and output, to one or more devices, AC and/or DC. Further, this device and method allow for the providing of all the needed other devices to fulfill the tag printing and related and other requirements (as more describe in the prior applications) in a single platform.

### BRIEF DESCRIPTION OF THE DRAWINGS

FIG. 1 is a front view of an embodiment of the device with the front and top shown in an open position.

FIG. 2 is a side view of an embodiment of the device shown in a closed state.

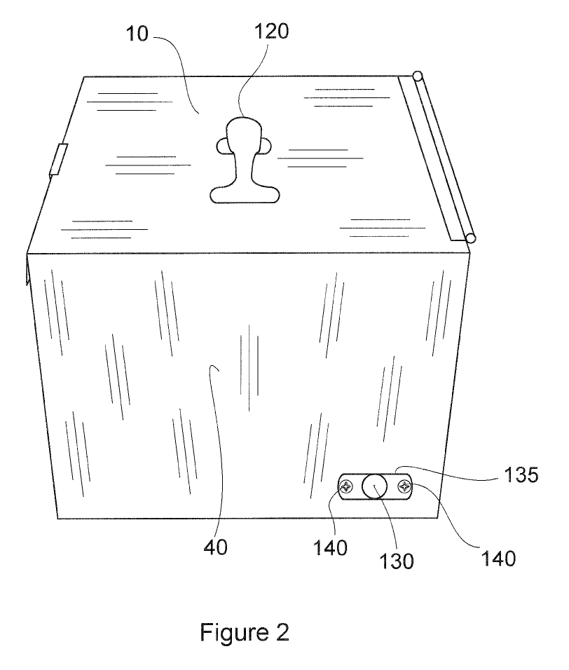

FIG. 3 is a front view of an embodiment of the device shown with the top open.

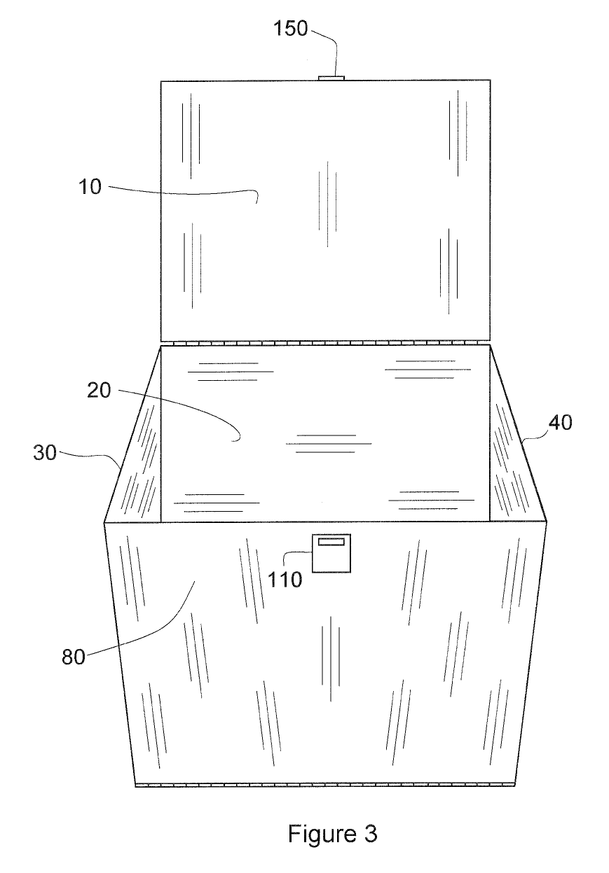

FIG. 4 is a view of the self.

### DETAILED DESCRIPTION OF THE INVENTION

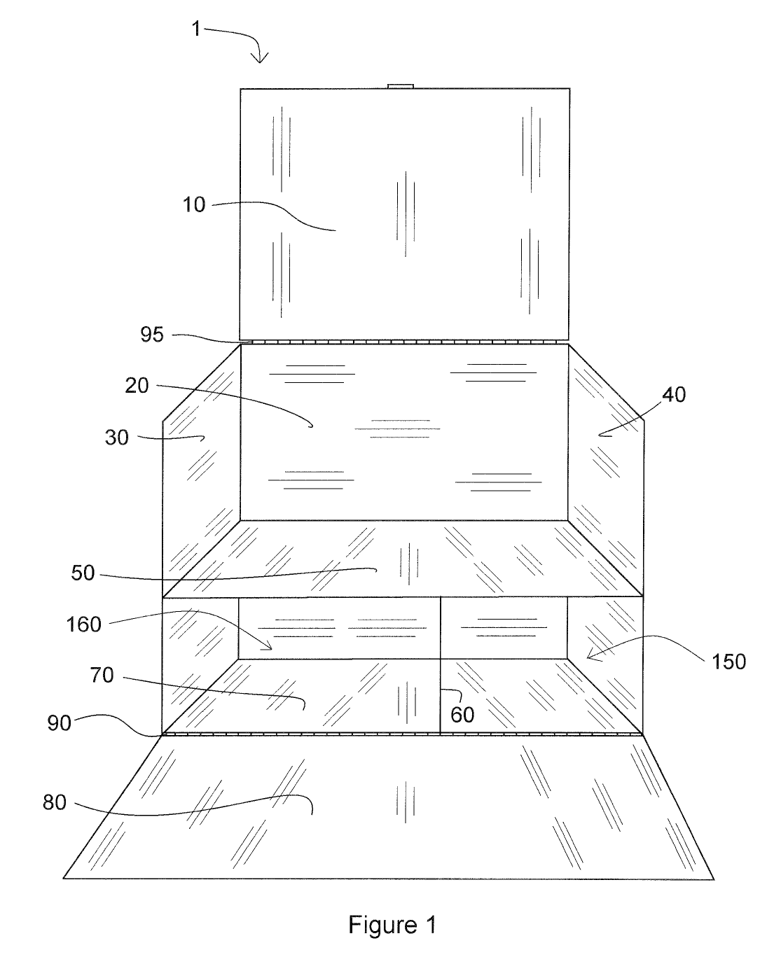

In FIG. 1 an embodiment of the device 1 is shown. In this embodiment, device 1 has top portion 10 which is connected to back portion 20 by hinge 95. A first side 30 is attached to back 20 and bottom 70. A second side 40 is also attached to back 20 and bottom 70. Front 80 is connected to bottom 70 by a hinge 90. Said hinges 90 and 95 allow for top 10 and front 80 to be opened, exposing the internal space of device 1.

On top 10 there may be a handle 120 to aid in the mobility of the device. Further, a latch 150 may be utilized to removably couple the top 10 and front 80.

Device 1 may have an opening 130 in which, among other things, an electrical cable may protrude through. A plate 135 may encircle opening 130 to act as a bushing for the electrical cable. Plate 135 may be attached to side 40 by screws 140.

In an embodiment, the width of device 1 may be approximately 12 inches, with a height of approximately 12 inches and a depth of 13.5 inches. Further, opening 130 may have a diameter of 1.25 inches.

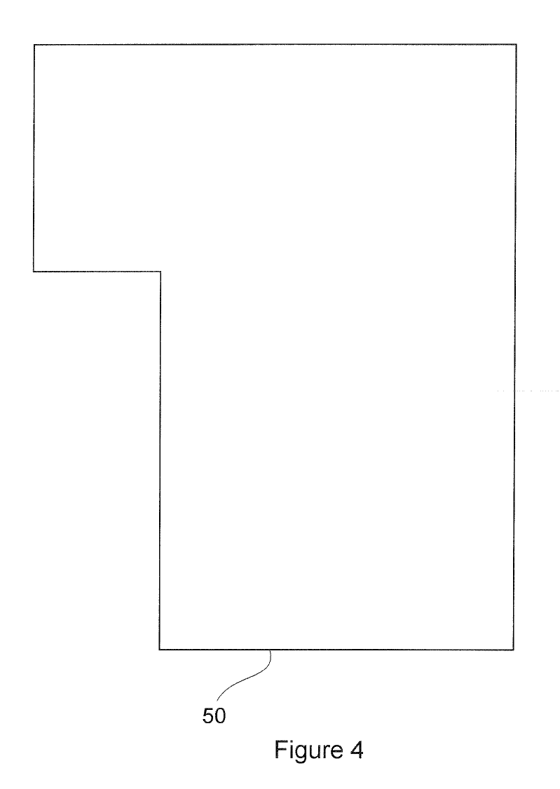

Inside of device 1 there may be a shelf 50. Shelf 50 may be attached to sides 30 and 40 and back 20. Further, perpendicular to and attached to bottom 70 and shelf 50 may be divider 60. Shelf 50 may be approximately the same size as bottom 70. As shown in FIG. 4, in another embodiment, shelf may feature a cut out portion on the end facing back 20. This portion may be 2 inches deep and 8.5 inches wide.

Device 1 may be constructed primarily of stainless steel. Further, device 1 may be powder coated.

In an embodiment, a printer may be placed on top of shelf 50 and located primarily closest to side 30. Further, a computing device may also be placed on top of shelf 50 and located primarily closest to side 40. Labels to be supplied to the printer may be located on the bottom portion 70 closest to side 30, i.e., in compartment area 160.

Located between shelf 50 and bottom portion 70 and closest to side 40, i.e., in compartment area 150, may be the power components. The power components create a dynamic power environment. The power components are configured to couple to a multitude of power source devices, such as a vehicle cigarette lighter, a battery, or a standard 120 volt outlet. The input power source may be AC or DC power. The power components should also be configured to provide one or more outputs in AC and/or DC.

Thus, the power components should include, among other things, an inverter to convert from DC to AC current. They may also include a transformer to convert form AC to DC current. Such inverter and related wires and circuitry should be carefully constructed. For example, one obstacle may be faced adapting the DC from a cigarette lighter to AC for a printer. Such a conversion in addition to the power requirements of the contemplated printer may create an environment wherein the printer does not have sufficient power. In such a case, a lower gauge of wiring should be utilized in the appropriate areas to support the required load, among other potential optimizations.

In operation, with the components disposed within, the computing device may receive and transmit data wirelessly. Said data, as disclosed in the prior application, may contain pertinent information related to the finished good being harvested. As previously mentioned, this data may include GPS coordinates. The computing device may either generate or retrieve an identification which is related to said data. This identification is then transmitted to the printer. The printer may then print the identification on a tag. After this, the tag may be placed on the finished good which was harvested.

This process, mainly happening in the field, which is an extremely harsh environment for a computing device and printer, thus requires adequate protection. This device helps to provide this protection. This device allows the electrical components to be taken to the field when and where the goods may be harvested while continuing to protect the electrical components.

In another embodiment the device 1 may contain an additional opening wherein said labels may be obtained without the opening of top 10 or front 80.

In another embodiment, the enclosure device may date different shapes, so long as it provides the necessary protection for contained and/or integrated devices.

The device may contain all the necessary components to fulfill the tag printing, and related and other requirements, as further detailed in the prior application, making it a single platform in a modular, mobile, efficient manner.

Information as herein shown and described in detail is fully capable of attaining the above-described object of the invention, the presently preferred embodiments of the invention, and is, thus, representative of the subject matter which is broadly contemplated by the present invention. The scope of the present invention fully encompasses other embodiments which may become obvious to those skilled in the art, and is to be limited, accordingly, by nothing other than the appended claims, wherein reference to an element in the singular is not intended to mean “one and only one” unless explicitly so stated, but rather “one or more.” All structural, electrical, and functional equivalents to the elements of the above-described preferred embodiment and additional embodiments that are known to those of ordinary skill in the art are expressly incorporated herein by reference and are intended to be encompassed by the present claims.

Moreover, it is not necessary for a device or method to address each and every problem sought to be solved by the present invention for it to be encompassed by the present claims. Furthermore, no element, component or method step in the present disclosure is intended to be dedicated to the public regardless of whether the element, component, or method step is explicitly recited in the claims. No claim element herein is to be construed under the provisions of 35 U.S. C. 112, sixth paragraph, unless the element is expressly recited using the phrase “means for.”

What is claimed is:

1. A device for protecting other devices comprising:
a top, bottom, first side, second side, back, and front portion;
said top portion coupled to said back portion by a hinge;
said back portion coupled to said first side, said second side and said bottom portion;
said bottom portion coupled to said first side, said second side and said back portion;
said front portion coupled to said bottom portion by a hinge;
either of said first side or second side portion containing an orifice;
said device containing electrical components for connecting to an input power source of alternating current and/or direct current;
said electrical components further including one or more power output for output of alternating current and/or direct current;
said device further adapted for harsh conditions while also adapted to integrate and/or contain electrical components and protecting said electrical components from harsh conditions.

2. The device of claim 1 wherein said electrical components include a printer;

3. The device of claim 2 wherein said printer is capable of printing a tag which may be attached to a finished good;

4. The device of claim 3 wherein said finished good is a harvested item of produce.

5. A method for attaching a tag to a finished good harvested in a agricultural field comprising the steps of:
protecting a computing device and printer by placing them in a device, said device comprising:
a top, bottom, first side, second side, back, and front portion;
said top portion coupled to said back portion by a hinge;
said back portion coupled to said first side, said second side and said bottom portion;
said bottom portion coupled to said first side, said second side and said back portion;
said front portion coupled to said bottom portion by a hinge;
either of said first side or second side portion containing an orifice;
said device containing electrical components for connecting to an input power source of alternating current and/or direct current;
said electrical components further including one or more power outputs for output of alternating current and/or direct current; and
said device further adapted for harsh conditions while also adapted to integrate and/or contain electrical components and protecting said electrical components from harsh conditions;
coupling said computing device to said one or more power outputs;
coupling said printer to said one or more power outputs;
transmitting data to said computing device;
transmitting said data from said computing device said printer;
printing a tag on said printer based on said data; and
attaching said tag to said finished good.
